(19) United States
(12) Patent Application Publication
(10) Pub. No.: US 2023/0029688 A1
(43) Pub. Date: Feb. 2, 2023

(54) Hot flow barbecue device

(71) Applicant: NINGBO AGSUN PRODUCTS,INC., CIXI (CN)

(72) Inventors: Xuefei Mao, CIXI (CN); Meng Lin, CIXI (CN); Xianghua Liu, CIXI (CN)

(73) Assignee: NINGBO AGSUN PRODUCTS,INC., CIXI (CN)

(21) Appl. No.: 17/965,790

(22) Filed: Oct. 14, 2022

(30) Foreign Application Priority Data
Aug. 12, 2022 (CN) 202222133844.6

(51) Int. Cl. A47J 37/07

(52) U.S. Cl. CPC A47J 37/0727

(57) ABSTRACT

The disclosure provides a hot flow barbecue device, where a burner is mounted in a combustion cavity to generate a hot air flow; an air inlet hole is provided on a combustion chamber, so that ambient cold air enters the combustion cavity from the air inlet hole; the combustion chamber is suspended vertically and has a height difference from the ground so as to generate a chimney effect to ensure power of the hot flow; the combustion cavity is separated from a heating port, so that the hot air flow mixes with the cold air flow during rise of the air flow; a heating space is arranged in a flat shape so as to increase contact area between the air flow and a uniform heating chamber.

### TECHNICAL FIELD

The disclosure pertains to the technical field of barbecue equipment, and specifically pertains to a hot flow barbecue device.

### BACKGROUND

The existing barbecue equipment comprises a grill body, a grill cavity is provided in the grill body, and a burner and a grill are mounted in the grill cavity. In order to facilitate heating of a large-area grill, a plurality of burners are provided below the grill. By controlling opening and closing of a single burner or all the burners, the grill is heated locally or totally. Since a flame of the burner is difficult to be distributed throughout the grill cavity, temperature distribution is uneven. Generally, a method of additionally providing a temperature equalization plate is used, but local high temperature easily occurs, oil in the barbecue process easily drips onto the burner or the temperature equalization plate, generating a large amount of harmful gas. In addition, oil is easily ignited after deposition, which may cause a safety hazard.

### SUMMARY

In view of the above analysis, the disclosure proposes a hot flow barbecue device to solve the deficiencies of the prior art.

The disclosure is mainly achieved by the following technical schemes:

The disclosure provides a hot flow barbecue device which comprises a grill body, a barbecue appliance, a hot flow assembly and a burner, where the hot flow assembly is provided on the grill body, the hot flow assembly comprises a combustion chamber and a uniform heating chamber, the combustion chamber is arranged suspended in a vertical direction, the combustion chamber is provided with a combustion cavity and an air inlet hole in communication with the combustion cavity, the burner is mounted in the combustion cavity, the uniform heating chamber is connected to a top of the combustion chamber and extends towards an outside thereof, the uniform heating chamber is provided with a hot flow channel, the hot flow channel is provided with a heating port facing the barbecue appliance, the barbecue appliance is placed on the grill body or the heating port, and the hot flow channel cooperates with the barbecue appliance at the heating port to form a heating space in communication with the combustion cavity and having a flat shape.

The burner is mounted in the combustion cavity to generate a hot air flow; the air inlet hole is provided on the combustion chamber, so that ambient cold air enters the combustion cavity from the air inlet hole; the combustion chamber is arranged suspended in the vertical direction and has a height difference from the ground so as to generate a chimney effect to ensure power of the hot flow; the combustion cavity is separated from the heating port, so that the hot air flow mixes with the cold air flow during rise of the air flow; the heating space is arranged in the flat shape so as to increase contact area between the air flow and the uniform heating chamber, so that the hot air flow and the external cold air flow fully mix before heating and then enter the hot flow channel to achieve a suitable heating temperature at the heating port and avoid the possibility of catching fire.

Further, the hot flow channel comprises a first space and at least one second space, tops of the first space and the second space are respectively provided with heating ports, the first space is connected to the top of the combustion cavity, the second space is located outside the first space, and the second space is in communication with the combustion cavity by the first space.

A plurality of second spaces are provided, and the combustion cavity and the corresponding first space may be provided in a middle portion of the hot flow assembly, and may also be provided on one side of the hot flow assembly, and may be adjusted according to function of the barbecue device. The barbecue appliance may be arranged integrally or in a split manner to form a plurality of independent roasting tools.

Further, the hot flow channel comprises at least two second spaces spaced apart from each other, bottoms of the second spaces are respectively connected to the top of the combustion cavity, ends of the second spaces extend towards an outside of the combustion cavity, and tops thereof are provided with heating ports.

The combustion cavity may be provided in a middle portion of the hot flow assembly, and may also be provided on one side of the hot flow assembly, and may be adjusted according to function of the barbecue device. The barbecue appliance may be arranged integrally or in a split manner to form a plurality of independent roasting tools.

Further, the top of the combustion cavity is provided with a through hole, a flow guide plate located below the heating port of the first space is rotatably mounted near the through hole, and the flow guide plate cooperates with an inner wall of the through hole or an inner wall of the first space to form a flow guide port provided towards an air inlet end of the second space.

When a heat conducting plate is placed horizontally, the heat conducting plate cooperates with the inner wall of the through hole or the inner wall of the first space to divert and guide the hot flow, which also makes the air flow arrive at the heating port of the first space more evenly mixed due to blocking by the heat conducting plate, so that simultaneous heating of the barbecue appliances on the first space and the second spaces can be realized. The heat conducting plate is rotated to cooperate with the inner wall of the through hole or the inner wall of the first space to quickly guide the hot air from the flow guide port to the corresponding second space to change the air flow distribution, so that it mainly supplies heat to the barbecue appliance on the corresponding second space.

Preferably, a bottom of the uniform heating chamber is provided with an oil discharge port in communication with at least one of the first space and the second space.

Further, a control element is provided between the first space and the second space to make the first space and the second space communicated or blocked.

By adjusting the control element, the second space may be individually closed or opened to heat different positions of the entire barbecue appliance or the roasting tools at different positions to perform zonal barbecue to enhance functionality of the barbecue device.

Further, the second space is internally provided with a control element for controlling opening or closing thereof

The control element comprises a partition plate and a baffle mounted on the uniform heating chamber, the partition plate is provided with several air outlets, and the baffle is rotatably or slidably arranged beside the partition plate so as to block or open the air outlets.

The partition plate and the baffle are located in the hot flow channel, and a single second space may be respectively closed or opened by adjusting the control element.

Further, the control element comprises a partition plate and a baffle mounted on the uniform heating chamber, the partition plate is provided with several air outlets, and the baffle is rotatably or slidably arranged beside the partition plate so as to block or open the air outlets.

The partition plate and the baffle are located in the hot flow channel, and when the hot flow channel comprises the first space and the second space, the partition plate divides the uniform heating chamber into the first space and the second space.

Further, an inner cover body vertically arranged is mounted in the combustion cavity, and the burner is mounted in the inner cover body.

The heating port is separated from the combustion cavity, and the uniform heating chamber extends towards an outside of the combustion chamber to offset the heating port from the burner, so that oil on the heating port cannot easily drip onto the burner, and since the inner cover body separates the burner from the inner wall of the combustion chamber, even in the case of no obstruction, the dripping oil flows from the uniform heating chamber to the inner wall of the combustion chamber, which cannot easily generate a large amount of oil smoke due to high temperature, and the inner cover body guides the air flow heated by the burner.

Further, the barbecue appliance comprises at least one roasting tool, which allows the air flow to heat the roasting tool.

Further, the roasting tool is a grill; or the roasting tool is a roasting pan, and the roasting pan is provided with an oil discharge channel in communication with the hot flow channel

Preferably, the oil discharge channel is an oil discharge groove or an oil discharge hole in communication with the second space.

Compared with the prior art, the beneficial effects of the technical scheme of the disclosure are as follows:

1. By respectively arranging the combustion chamber and the uniform heating chamber extending towards the outside of the combustion chamber, the hot flow barbecue device of the disclosure separates the heating port from the combustion cavity, so that the oil of the heating port does not easily drip onto the burner in the combustion cavity, and the barbecue appliance on the heating port is heated after the hot air and the external cold air are well mixed due to extension of an air flow path, so that the heating temperature is suitable and it is not easy to catch fire.

2. By dividing the hot flow channel into a plurality of spaces and providing the control elements in the spaces, the barbecue appliance can be subject to zonal heating, making full use of a heat source, improving the barbecue efficiency and reducing energy consumption.

### BRIEF DESCRIPTION OF THE DRAWINGS

In order to illustrate the technical schemes in the embodiments of the disclosure more clearly, a brief description will be given below with reference to the accompanying drawings which are used in the description of the embodiments. Obviously, the drawings in the following description are only some embodiments of the disclosure. For those of ordinary skill in the art, other drawings can also be obtained from these drawings without creative effort.

FIG. 1 is a stereographic view of a hot flow barbecue device according to an embodiment of the disclosure;

FIG. 2 is a structural diagram of a grill body according to an embodiment of the disclosure;

FIG. 3 is a structural diagram of a hot flow assembly and a barbecue appliance according to an embodiment of the disclosure;

FIG. 4 is a sectional view of FIG. 3;

FIG. 5 is a structural diagram (I) of Embodiment 1 of the heat flow assembly according to an embodiment of the disclosure;

FIG. 6 is a structural diagram (II) of Embodiment 1 of the hot flow assembly according to the embodiment of the disclosure; and

FIG. 7 is a sectional view of Embodiment 2 of the hot flow assembly according to the embodiment of the disclosure.

Reference numerals are as follows:

1. grill body, 1a. mounting port, 1b. horizontal step, 2. barbecue appliance, 21. grill, 22.

roasting pan, 22a. oil discharge channel, 3. hot flow assembly, 31. combustion chamber, 31a. combustion cavity, 31b. air inlet hole, 31c. through hole, 31d. flow guide port, 31e, mounting hole, 32, uniform heating chamber, 32a. heating port, 32b. heating space, 32c. first space, 32d. second space, 32e. oil discharge port, 33. flow guide plate, 34. control element, 341. partition plate, 341a. air outlet, 342, baffle, 4. burner, 5. inner cover body, 6. first rotating shaft, 7. second rotating shaft.

### DESCRIPTION OF THE EMBODIMENTS

In order to enable those skilled in the art to have a better understanding of the disclosure and thereby more clearly define the scope of the invention, the disclosure will be described in detail below with respect to some specific embodiments of the disclosure. It should be noted that the following description only relates to some specific embodiments of the inventive concept and are only part of the embodiments of the disclosure, specific and direct descriptions of relevant structures are merely for the convenience of understanding the disclosure, and the specific features do not, of course, directly limit the implementation scope of the disclosure. Conventional choices and alternatives made by those skilled in the art under the guidance of the inventive concept, should be considered within the protection scope of the disclosure.

The disclosure will be further described below in conjunction with the accompanying drawings and specific embodiments.

### Embodiment 1

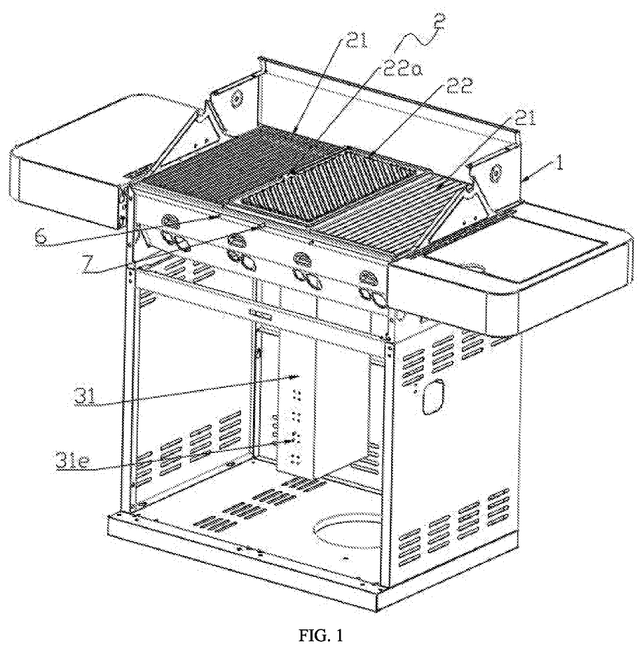

As shown in FIGS. 1 to 6, the disclosure provides a hot flow barbecue device which comprises a grill body 1, a barbecue appliance 2, a hot flow assembly 3 and a burner 4. The barbecue appliance 2 comprises at least one roasting tool which is a grill 21 or a roasting pan 22.

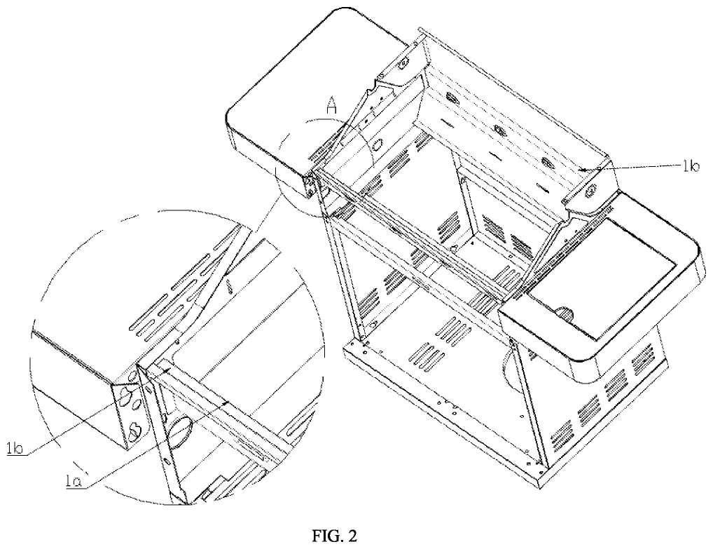

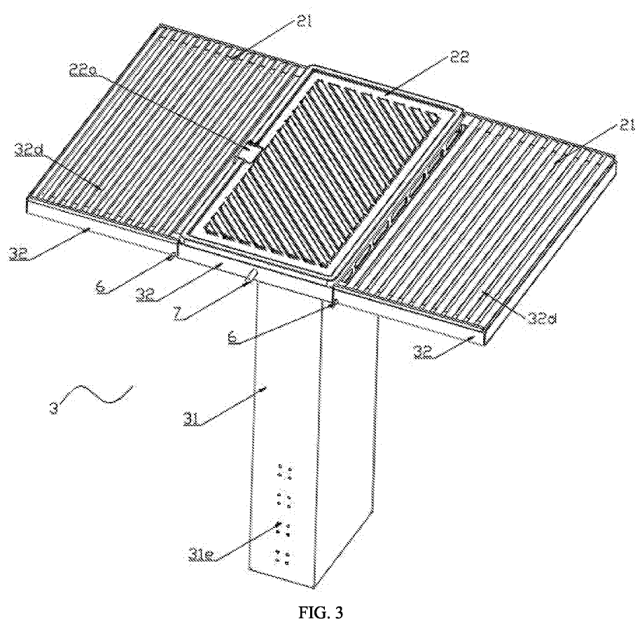

As shown in FIGS. 1 and 3, the hot flow assembly 3 is provided on the grill body 1, the hot flow assembly 3 comprises a combustion chamber 31 and a uniform heating chamber 32, and the uniform heating chamber 32 is fixed on the grill body 1 by a screw or placed on the grill body 1. As shown in FIG. 2, in this embodiment, the grill body 1 is provided with an mounting port 1a, at least two opposite inner walls of the mounting port 1a are provided with horizontal steps 1b, and the uniform heating chamber 32 is placed on the horizontal steps 1b.

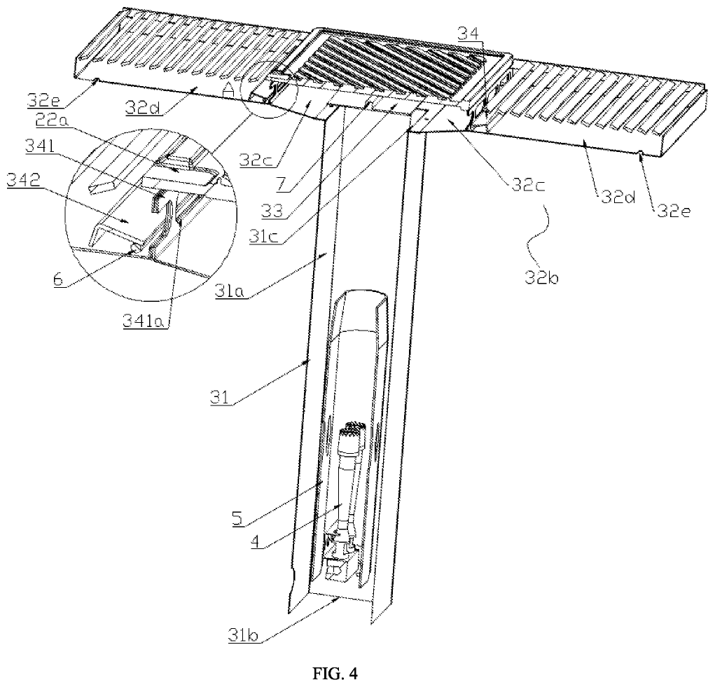

As shown in FIGS. 3 and 4, the combustion chamber 31 is provided with a combustion cavity 31a and an air inlet hole 31b in communication with the combustion cavity 31a, a top of the combustion chamber 31 is connected to the uniform heating chamber 32, so that the combustion chamber 31 can be suspended vertically, the air inlet hole 31b provided at a bottom thereof forms a height difference with the ground, the uniform heating chamber 32 extends towards an outside of the combustion chamber 31, a hot flow channel is provided in the uniform heating chamber 32, a top of the hot flow channel is provided with heating ports 32a facing the barbecue appliance 2, the barbecue appliance 2 is placed on the heating ports 32a, and the barbecue appliance 2 may also be placed on the grill body 1 facing the heating ports 32a. The hot flow channel cooperates with the barbecue appliance 2 at the heating ports 32a to form a heating space 32b in communication with the combustion cavity 31a and having a flat shape. A height of the heating space 32b is between 10 mm and 40 mm, and specifically limited to a vertical distance between a bottom of the heating space 32b and a top of the heating space 32b.

The burner 4 is mounted in the combustion cavity 31a, and specifically, an inner cover body 5 arranged vertically is mounted in the combustion cavity 31a, and the inner cover body 5 is arranged at a distance from an inner wall of the combustion cavity 31a, and is assembled with the combustion chamber 31 by a connector. The burner 4 is mounted in the inner cover body 5 which penetrates up and down by a connector, and is arranged at a distance from an inner wall of the inner cover body 5. In this embodiment, a plurality of groups of mounting holes 31e are arranged apart vertically on a side wall of the combustion chamber 31, mounting height of the burner 4 and the inner cover body 5 may be adjusted to match a corresponding heating temperature at the heating ports 32a, a pipeline port for mounting a gas pipe is further provided on the side wall of the combustion chamber 31, and a cross sectional shape of the combustion chamber 31 is a rectangle and may be adjusted according to needs. The inner cover body 5 is open at a bottom, and a top side wall thereof extends obliquely and is tapered.

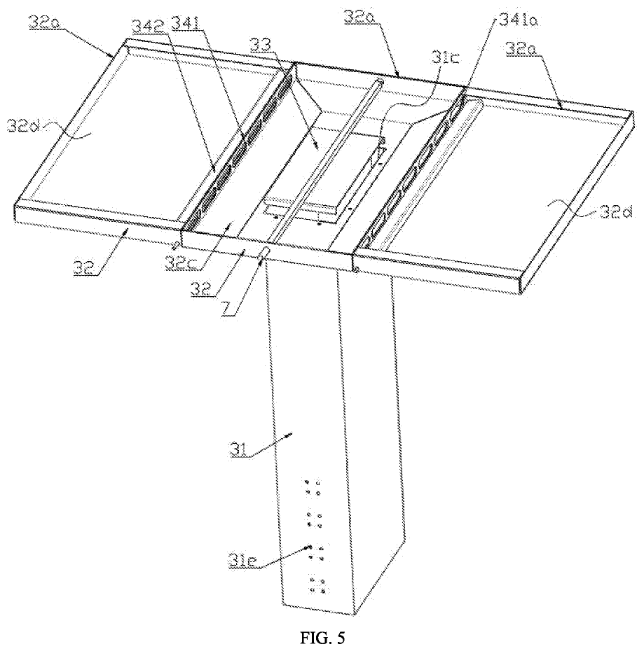

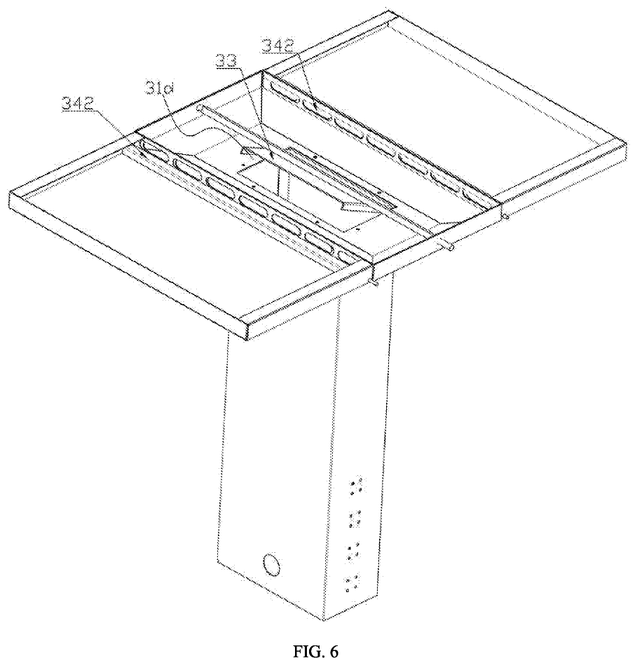

As shown in FIGS. 5 and 6, preferably, the hot flow channel comprises a first space 32c and at least one second space 32d, tops of the first space 32c and the second space 32d are respectively provided with heating ports 32a, the first space 32c is detachably connected to the top of the combustion cavity 31a by a screw to facilitate assembly or disassembly and cleaning.

There are two second spaces 32d, the second spaces 32d are located at two opposite outsides of the first space 32c, and there may also be a plurality of second spaces which are spaced apart in a circumferential direction of the first space 32c. The second spaces 32d are in communication with the combustion cavity 31a by the first space 32c, and the combustion chamber 31 is located in the middle between the two second spaces 32d. The plurality of second spaces 32d may all be provided on the same side of the first space 32c, so that the combustion chamber 31 is located on the side of the second spaces 32d, or the combustion chamber 31 may also be located on the side of the first space 32c, and may be adjusted according to function of the barbecue device.

The uniform heating chamber 32 is arranged in a split manner to form two cover bodies connected against and placed on the mounting port 1a or cover bodies connected by screws and placed on the mounting port 1a, tops of the two cover bodies are arranged open to form the heating ports 32a, a connection of the two cover bodies is open for fit and communication, and since the uniform heating chamber 32 may be placed on the mounting port 1a of the grill body 1, the second spaces 32d may be separately removed for cleaning.

As shown in FIGS. 5 and 6, specifically, a through hole 31c is provided at the top of the combustion cavity 31a, a flow guide plate 33 located below the heating ports 32a of the first space 32c is rotatably mounted near the through hole 31c, and the flow guide plate 33 cooperates with an inner wall of the through hole 31c or the inner wall of the first space 32c to form a flow guide port 31d arranged towards an air inlet end of the second space 32d.

In this embodiment, the flow guide plate 33 is provided in the first space 32c or the combustion cavity 31a, and is specifically provided in the first space 32c, a side wall of the uniform heating chamber 32 is perforated with a second rotating shaft 7 located between the through hole 31c and the heating ports 32a of the first space 32c, and the second rotating shaft 7 is fixed on an upper surface of the flow guide plate 33. When it is necessary to heat one second space 32d in a concentrated manner, the flow guide plate 33 is rotated to incline the flow guide plate 33 to abut against one of the inner wall of the through hole 31c, the inner wall of the uniform heating chamber 32 and the barbecue appliance 2, specifically to abut against a lower surface of the barbecue appliance 2. At least one end of the second rotating shaft 7 passes through the grill body 1 to facilitate adjustment outside the grill body 1.

The barbecue appliance 2 may be arranged integrally such that different heating ports 32a heat different positions of the barbecue appliance 2. The barbecue appliance 2 may also be arranged in a split manner, and comprises a plurality of roasting tools, different heating ports 32a may be provided with an identical roasting tool such as a grill 21 or a roasting pan 22 to simultaneously heat the roasting tools at different positions. The flow guide plate 33 is rotated to an inclined state such that the hot flow may mainly act on the corresponding second space 32d, or the flow guide plate 33 is rotated to be level with the through hole 31c such that the hot flow may simultaneously act on the first space 32c and the second space 32d in a relatively uniform manner.

It is also possible to provide different roasting tools on different heating ports 32a, for example, the roasting pan 22 is placed on the heating ports 32a of the first space 32c, which can prevent oil on food dripping from the heating ports 32a to the burner 4 below a bottom of the first space 32c during a barbecue process and is not easy to generate smoke. At the same time, the roasting pan 22 is in tight fit with the corresponding heating ports 32a so as to avoid overflow of hot air flow before entering the second space 32d. In order to discharge the oil in the roasting pan 22 in time, the roasting pan 22 is provided with an oil discharge channel 22a in communication with the hot flow channel, and specifically an oil discharge groove is provided on the edge of the roasting pan 22. An outer end of the oil discharge groove extends above the heating ports 32a of the second space 32d.

It is also possible to place a grill on the heating ports 32a of the first space 32c, and the oil dripping from the grill is blocked by the flow guide plate 33. When the flow guide plate 33 needs to be rotated, no food is placed on the grill, and even if food is placed, the oil cannot easily drip onto the burner 4 due to blocking of the inner cover body 5. In order to avoid overflow of the hot flow from the heating ports 32a of the first space 32c due to placement of the grill and affecting heating effect of the second space 32d, a length of the flow guide plate 33 may be appropriately extended to reduce heat loss.

The grill 21 is arranged on the heating ports 32a of the second space 32d so that the oil drips to a bottom of the uniform heating chamber 32 when the food is roasted, and may also be provided with the roasting plate 22, and an oil discharge groove or an oil discharge hole in communication with the second space 32d is provided on the roasting plate 22.

In order to reduce workload of cleaning a bottom surface of the uniform heating chamber 32, an oil discharge port 32e is provided at the bottom thereof so as to discharge part of the oil, and the bottom surface of the uniform heating chamber 32 may also be provided with a slope, so that the oil discharge port 32e is located at a lowest part of the uniform heating chamber 32 to reduce accumulation of the oil on the bottom surface of the uniform heating chamber 32. The oil discharge port 32e is in communication with at least one of the first space 32c and the second space 32d, and specifically, the oil discharge port 32e is provided at the bottom of the uniform heating chamber 32 so as to be in communication with the second space 32d. In order to prevent the oil from dripping from the oil discharge port 32e to the ground or the grill body 1, an oil storage box in communication with the oil discharge port 32e may be detachably mounted at the bottom of the uniform heating chamber 32, or an oil storage box with an open top may be detachably mounted below the oil discharge port 32e of the uniform heating chamber 32 to facilitate removal of the oil.

When a plurality of second spaces 32d are provided, in order to achieve full utilization of the hot flow, preferably, a control member 34 is provided between the first space 32c and the second space 32d to make them communicated or blocked.

As shown in FIG. 4, the control element 34 comprises a partition plate 341 and a baffle 342 mounted on the uniform heating chamber 32, the partition plate 341 is provided with several air outlets 341a, and the baffle 342 is rotatably or slidably arranged beside the partition plate 341 so as to block or open the air outlets 341a.

In this embodiment, the partition plate 341 is integrally connected to open ends of the first space 32c and the second space 32d to achieve separation of the uniform heating chamber 32, a plurality of air outlets 341a are arranged apart on the partition plate 341, and the oil at the bottom of the second space 32d is blocked by the partition plate 341 to prevent the oil from flowing into the first space 32c and the combustion cavity 31a. One partition plate 341 may be provided between a connecting end of the first space 32c and the second space 32d. The partition plate 341 may be arranged in a split manner and fixed to the second space 32d or the first space 32c by screws.

A side wall of the uniform heating chamber 32 is perforated with a first rotating shaft 6, the first rotating shaft 6 is fixed on one side of the baffle 342, and the other side of the baffle 342 movably cooperates with the partition plate 341. At least one end of the first rotating shaft 6 passes through the grill body 1 to facilitate adjustment outside the grill body 1. The side wall of the uniform heating chamber 32 may be perforated with a pull rod fixed to the baffle 342, the baffle 342 is arranged attached to the partition plate 341, and the baffle 342 is pulled to open or close the air outlets 341a.

In this embodiment, since the hot flow has a certain acting force on the baffle 342 when the air outlets 341a are closed, in order to ensure structural strength of the baffle 342, a cross section of the baffle 342 is L-shaped; when the baffle 342 opens the air outlets 341a, a short side thereof abuts against the bottom of the uniform heating chamber 32, and a long side thereof is obliquely arranged; and when the baffle 342 closes the air outlets 341a, the baffle 342 is obliquely arranged.

In order to prevent the baffle 342 from automatic return when being rotated to abut against the partition plate 341, a proportion relationship between the long side and the short side of the baffle 342 is adjusted to lower a center of gravity of the baffle 342 so that it is not easy to return, and an assembly hole of the first rotating shaft 6 has a certain gap from the partition plate 341, so that the baffle 342 is obliquely arranged when abutting against the partition plate 341 so as to be placed more stably. Although a small amount of heat runs to the second space 32d which does not need to be heated due to inclination of the baffle 342, it is not necessary to completely close the air outlets 341a when the baffle 342 abuts against the partition plate 341 because a flow rate of the heat flow is small and negligible.

In order to facilitate rotation of the flow guide plate 33, it is not necessary to completely divide the first space 32c into two parts when the flow guide plate 33 is inclined, and whether the second space 32d is closed or not mainly depends on whether the air outlets 341a are closed or not and has little to do with the flow guide plate 33.

As shown in FIGS. 4 and 5, when the air outlets 341a on both sides of the first space 32c are open, the hot air flow from the through hole 31c is divided under the guiding action of the horizontally arranged flow guide plate 33 and is respectively guided into the two second spaces 32d from the corresponding air outlets 341a to simultaneously heat the grills 21 on both sides and the roasting pan in the middle 22. As shown in FIG. 6, the baffle 342 on a right side is rotated to close the air outlets 341a on one partition plate 341 on the second space 32d on the right side, and then the flow guide plate 33 is rotated until a left side thereof abuts against a bottom of the roasting pan 22, and at this time, a right side of the flow guide plate 33 is close to the inner wall on one side of the through hole 31c, and the flow guide plate 33, the through hole 31c and a bottom surface of the first space 32c form an upwardly inclined flow guide port 31d, so that more hot flow quickly moves from the flow guide port 31d to the air outlets 341a which are not closed on the left side to mainly heat the grill 21 on the left side, and assist to heat the roasting pan 22, so that the heat is more concentrated. When the air outlets 341a on both sides of the first space 32c are closed, the flow guide plate 33 is horizontally arranged so that the hot air flow evenly heat the roasting pan 22 in the middle, and when the flow guide plate 33 is obliquely arranged, the roasting pan 22 is subject to local focused heating.

### Embodiment 2

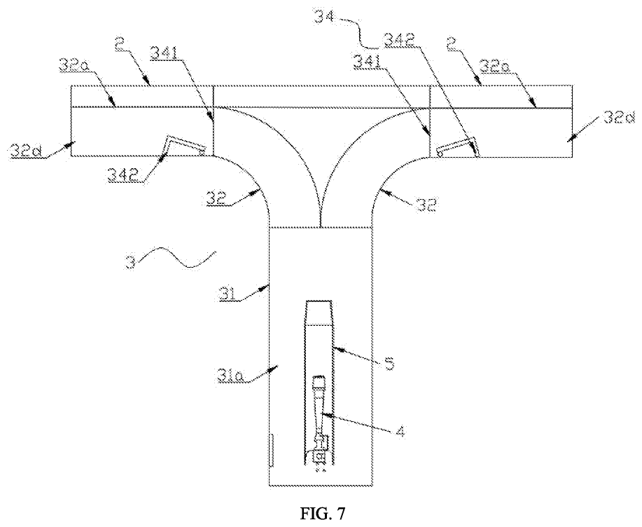

As shown in FIG. 7, the disclosure provides a hot flow barbecue device which comprises a grill body, a barbecue appliance 2, a hot flow assembly 3 and a burner 4. The barbecue appliance 2 comprises two roasting tools. The hot flow assembly 3 comprises a combustion chamber 31 and a uniform heating chamber 32, and the uniform heating chamber 32 is placed on the grill body. The combustion chamber 31 is provided with a combustion cavity 31a and an air inlet hole in communication with the combustion cavity 31a, a top of the combustion chamber 31 is connected to the uniform heating chamber 32, the air inlet hole is provided at a bottom of the combustion chamber 31, the uniform heating chamber 32 extends towards an outside of the combustion chamber 31, a hot flow channel is provided in the uniform heating chamber 32, a top of an outer end of the hot flow channel is provided with heating ports 32a facing the barbecue appliance 2, and the barbecue appliance 2 is placed on the heating ports 32a. The hot flow channel cooperates with the barbecue appliance 2 at the heating ports 32a to form a heating space in communication with the combustion cavity 31a and having a flat shape.

An inner cover body 5 arranged vertically is mounted in the combustion cavity 31a, and the inner cover body 5 is arranged at a distance from an inner wall of the combustion cavity 31a, and is assembled with the same by a connector. The burner 4 is mounted in the inner cover body 5 by a connector, and is arranged at a distance from an inner wall of the inner cover body 5.

This embodiment differs from Embodiment 1 in that the hot flow channel comprises two second spaces 32d spaced apart but not limited to two second spaces, bottoms of the second spaces 32d are respectively connected to a top of the combustion cavity 31a, ends of the second spaces 32d extend towards an outside of the combustion cavity 31a, and tops of outer ends of the second spaces 32d are provided with heating ports 32a, and bottoms thereof are provided with oil discharge ports. A connecting plate made of an insulating material or a non-insulating material may be provided between the two heating ports 32a for placing tools or dishes.

In this embodiment, each of the second spaces 32d is provided with a control member 34 for controlling opening or closing thereof. The control element 34 comprises a partition plate 341 and a baffle 342 mounted on the uniform heating chamber 32, the partition plate 341 is provided with several air outlets (not shown in the figure), and the baffle 342 is rotatably or slidably arranged beside the partition plate 341 so as to block or open the air outlets.

The partition plate 341 is provided in each second space 32d, and in order to facilitate mounting of the partition plate 341 and the baffle 342, the second spaces 32d have a split structure. Specific structures of the grill body, the combustion chamber 31, the barbecue appliance 2, the control element 34, and the related components thereof have been described in detail in Embodiment 1 and will not be repeated here.

The above description merely relates to preferred embodiments of the disclosure, the protection scope of the disclosure is not limited to the above embodiments, and all the technical schemes falling within the inventive concept fall within the protection scope of the disclosure. It should be noted that several modifications and variations can be made to the disclosure by those of ordinary skill in the art without departing from the principle of the disclosure, and those modifications and variations shall be also considered within the protection scope of the disclosure.

What is claimed is:

1. A hot flow barbecue device, comprising a grill body, a barbecue appliance, a hot flow assembly and a burner, wherein the hot flow assembly is provided on the grill body, the hot flow assembly comprises a combustion chamber and a uniform heating chamber, the combustion chamber is suspended vertically, the combustion chamber is provided with a combustion cavity and an air inlet hole in communication with the combustion cavity, the burner is mounted in the combustion cavity, the uniform heating chamber is connected to a top of the combustion chamber and extends towards an outside thereof, the uniform heating chamber is provided with a hot flow channel, the hot flow channel is provided with a heating port facing the barbecue appliance, the barbecue appliance is placed on the grill body or the heating port, and the hot flow channel cooperates with the barbecue appliance at the heating port to form a heating space in communication with the combustion cavity and having a flat shape.

2. The hot flow barbecue device of claim 1, wherein the hot flow channel comprises a first space and at least one second space, tops of the first space and the second space are respectively provided with heating ports, the first space is connected to the top of the combustion cavity, the second space is located outside the first space, and the second space is in communication with the combustion cavity by the first space.

3. The hot flow barbecue device of claim 1, wherein the hot flow channel comprises at least two second spaces spaced apart from each other, bottoms of the second spaces are respectively connected to the top of the combustion cavity, ends of the second spaces extend towards an outside of the combustion cavity, and tops thereof are provided with heating ports.

4. The hot flow barbecue device of claim 2, wherein the top of the combustion cavity is provided with a through hole, a flow guide plate located below the heating port of the first space is rotatably mounted near the through hole, and the flow guide plate cooperates with an inner wall of the through hole or an inner wall of the first space to form a flow guide port arranged towards an air inlet end of the second space; and
a bottom of the uniform heating chamber is provided with an oil discharge port in communication with at least one of the first space and the second space.

5. The hot flow barbecue device of claim 2, wherein a control element is provided between the first space and the second space to make the first space and the second space communicated or blocked.

6. The hot flow barbecue device of claim 3, wherein the second space is internally provided with a control element for controlling opening or closing thereof; and
the control element comprises a partition plate and a baffle mounted on the uniform heating chamber, the partition plate is provided with several air outlets, and the baffle is rotatably or slidably arranged beside the partition plate so as to block or open the air outlets.

7. The hot flow barbecue device of claim 5, wherein the control element comprises a partition plate and a baffle mounted on the uniform heating chamber, the partition plate is provided with several air outlets, and the baffle is rotatably or slidably arranged beside the partition plate so as to block or open the air outlets.

8. The hot flow barbecue device of claim 1, wherein an inner cover body vertically arranged is mounted in the combustion cavity, and the burner is mounted in the inner cover body.

9. The hot flow barbecue device of claim 1, wherein the barbecue appliance comprises at least one roasting tool.

10. The hot flow barbecue device of claim 9, wherein the roasting tool is a grill;
or the roasting tool is a roasting pan, and the roasting pan is provided with an oil discharge channel in communication with the hot flow channel
